(19) United States
(12) Patent Application Publication
(10) Pub. No.: US 2014/0206231 A1
(43) Pub. Date: Jul. 24, 2014

(54) ELECTRICAL CONNECTOR WITH IMPROVED TERMINALS

(71) Applicant: HON HAI PRECISION INDUSTRY CO., LTD., New Taipei (TW)

(72) Inventors: HUI-GANG GUO, Kunshan (CN); HONG-FANG WANG, Kunshan (CN)

(73) Assignee: HON HAI PRECISION INDUSTRY CO., LTD., New Taipei (TW)

(21) Appl. No.: 14/161,579

(22) Filed: Jan. 22, 2014

(30) Foreign Application Priority Data
Jan. 22, 2013 (CN) 201320032329.7

(51) Int. Cl. H01R 13/648

(52) U.S. Cl. CPC H01R 13/648
USPC 439/607.01

(57) ABSTRACT

An electrical connector includes an insulative housing defining a plurality of terminal slots. A plurality of conductive terminals are retained in the insulative housing and arranged in a row, each terminal includes a retaining portion received in the terminal slot, a contacting portion extending forwardly from a front portion of the retaining portion, a soldering portion extending outside of the insulative housing from the retaining portion and a resilient contacting arm extending forwardly from a rear portion of the retaining portion. A shield shell is covering the insulative housing and defines a notch at a rear portion thereof for receiving the contacting arm therein and at least a contacting pad disposed in the notch. The plurality of conductive terminals include a plurality of grounding terminals and signal terminals, and the at least one contacting pad contacts with contacting arm of a grounding terminal.

### BACKGROUND OF THE INVENTION

1. Field of the Invention

The present invention relates to an electrical connector, and more particularly to an electrical connector having improved terminals for grounding function.

2. Description of the Related Art

Taiwan Pat. No. 1369822 issued on Aug. 1, 2012, discloses an electrical connector assembly including a cable-side connector and a board-side connector. Each of the cable-side connector and the board-side connector includes an insulative housing, a plurality of terminals retained in the insulative housing and a shield shell covering the insulative housing, the insulative housing defines a plurality of terminal slot for receiving the terminals. The electrical connector assembly can achieve grounding function by welding a grounding bar on the cable-side connector, however it will reduce efficiency to separately weld the grounding bar and it is more difficult to adjust the grounding terminals.

Therefore, an improved electrical connector is highly desired to meet overcome the requirement.

### BRIEF SUMMARY OF THE INVENTION

An object of the present invention is to provide an electrical connector having grounding function by adjusting the sizes of the conductive terminals and the shield shell.

In order to achieve above-mentioned object, an electrical connector includes an insulative housing defining a plurality of terminal slots. A plurality of conductive terminals are retained in the insulative housing and arranged in a row, each terminal includes a retaining portion received in the terminal slot, a contacting portion extending forwardly from a front portion of the retaining portion, a soldering portion extending outside of the insulative housing from the retaining portion and a resilient contacting arm extending forwardly from a rear portion of the retaining portion. A shield shell is covering the insulative housing and defines a notch at a rear portion thereof for receiving the contacting arm therein and at least a contacting pad disposed in the notch. The plurality of conductive terminals include a plurality of grounding terminals and signal terminals, and the at least one contacting pad contacts with contacting arm of a grounding terminal.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the present invention;

FIG. 2 is another perspective view of the electrical connector shown in FIG. 1;

FIG. 3 is an exploded perspective view of the electrical connector shown in FIG. 2;

FIG. 4 is another exploded perspective view of the electrical connector shown in FIG. 3; and

FIG. 5 is a section view of the electrical connector shown in FIG. 1 taken along line 5-5.

### DESCRIPTION OF PREFERRED EMBODIMENT OF THE INVENTION

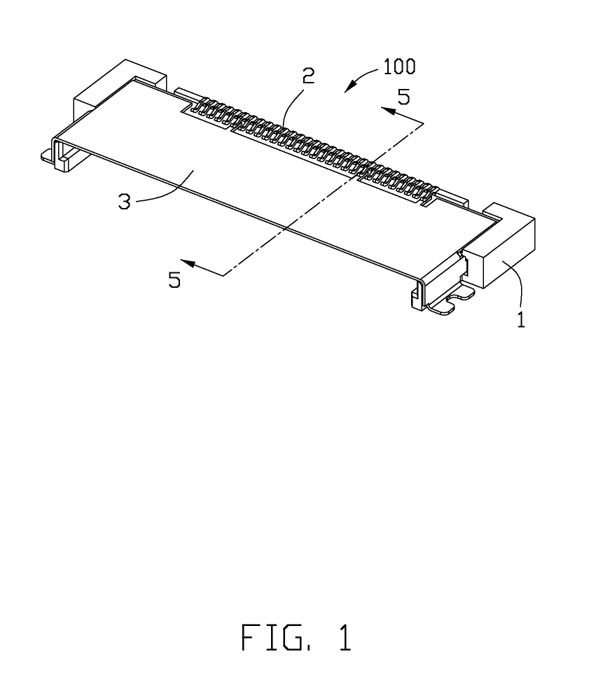

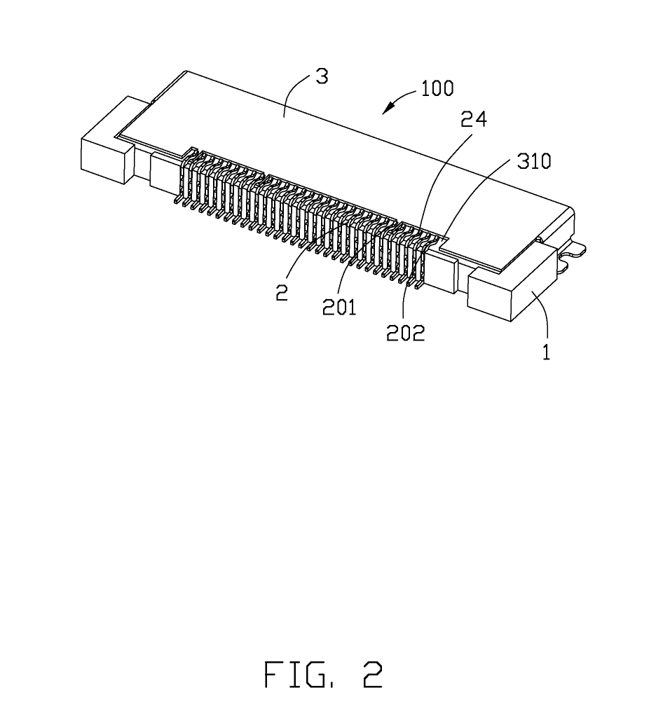

Reference will now be made to the drawing figures to describe a preferred embodiment of the present invention in detail. FIG. 1 and FIG. 2 disclose an electrical connector 100 used to be mounted onto a print circuit board in accordance with the present invention. The electrical connector 100 includes an insulative housing 1, a plurality of conductive terminals 2 retained in the insulative housing 1 and a shield shell 3 covering the insulative housing 1.

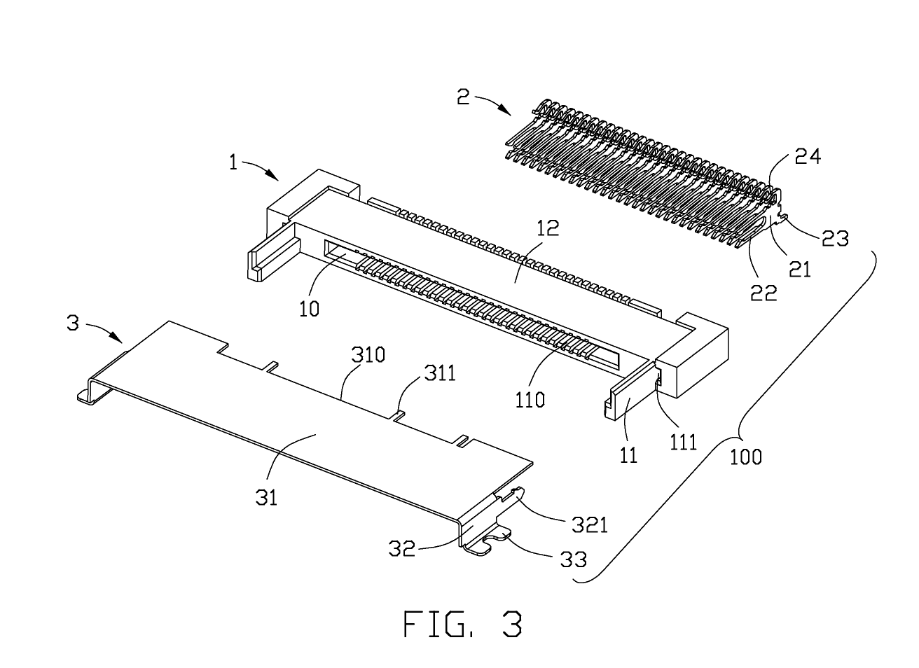

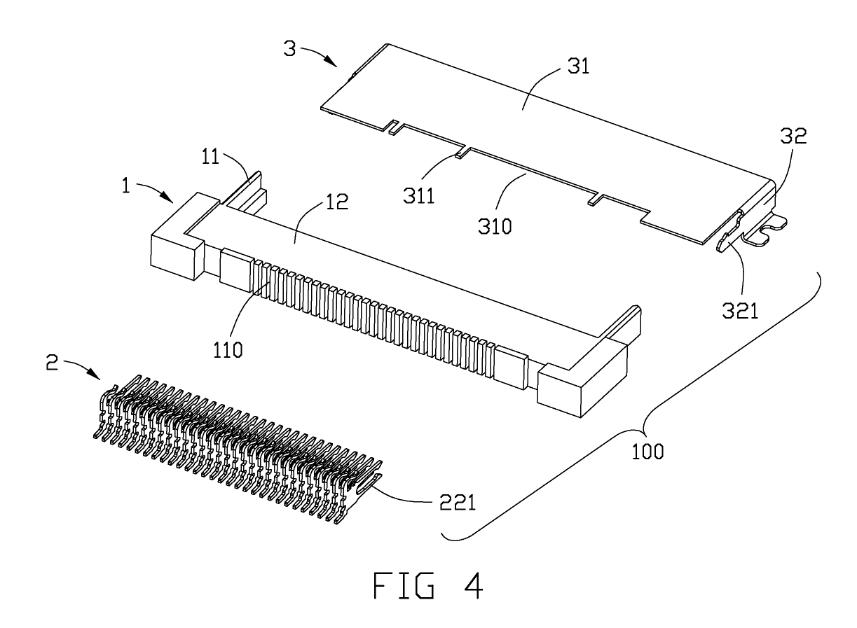

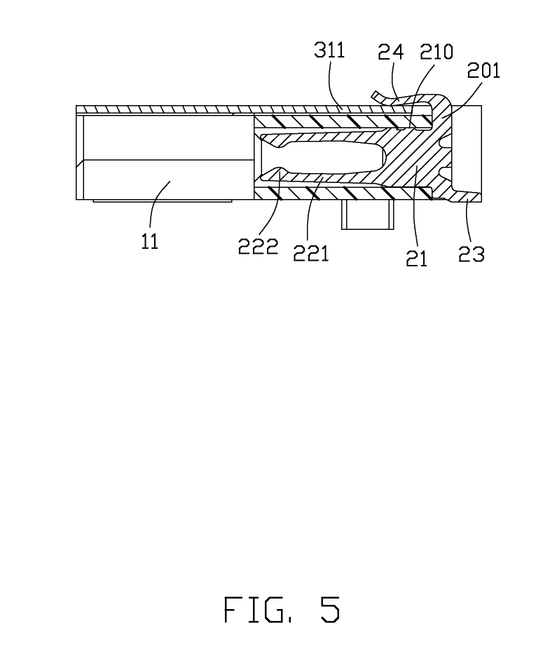

Referring to FIGS. 3 to 5, the insulative housing 1 is elongated shape and includes a mating cavity 10 running through a front surface of the insulative housing 1, a pair of guiding arms 11 extending forwardly from two longitudinal ends of the insulative housing 1 and a plurality of terminal slots 110 running through the front and rear surfaces of the insulative housing 1. The plurality of conductive terminals 2 are mounted into the terminal slots 110 from the rear surface of the insulative housing 1 and arranged in a longitudinal direction.

The conductive terminals each is flaky and includes a retaining portion 21 received in the terminal slot 110, a contacting portion 22 extending forwardly from the retaining portion 21, a soldering portion 23 bending rearwardly to extend outside of the insulative housing 1 from the retaining portion 21 and an resilient contacting arm 24 bending upwardly from the retaining portion 21 and extending forwardly. The resilient contacting arm 24 and the soldering portion 23 extend from the upper and lower edges of a rear portion of the retaining portion 21 respectively. The contacting portion 22 defines a pair of elastic arms 221 arranged in a vertical direction and received in the mating cavity 10, the pair of elastic arms 221 define projecting portions 222 opposite to each other for making the conductive terminals more stable connecting with the terminals of a mating connector. A barb 210 is projecting obliquely to rearwardly extend from the upper edge of the retaining portion 21 and interference fitting with the insulative housing 1 so that the conductive terminals 2 are stablily received in the insulative housing 1 and will not rearwardly move under an external force. The resilient contacting arm 24 is bent to extend toward the barb 210 from the rear edge of the barb 210.

The shield shell 3 includes a body portion 21 shielded the insulative housing 1, a pair of sidewalls 32 extending downwardly from the front end of the body portion 31 and a pair of soldering feet 33. The body portion 31 of the shield shell 3 is received in a recess 12 located on the upper side of the insulative housing 1 and shields the guiding arms 11 of insulative housing 1 to form an engaging space for receiving the mating connector. The body portion 31 defines a notch 310 at a rear portion thereof and a plurality of contacting pads 311 located in the notch 310, the resilient contacting arms 24 are located in the notch 310 and the plurality of contacting pads 311 are flat against the recess 12 of the insulative housing 1.

The conductive terminals 2 include a plurality of grounding terminals 201 and a plurality of signal terminals 202, the resilient contacting arms 24 of the grounding terminals 201 are pressed against the corresponding contacting pads of the shield shell 3 and the resilient contacting arms 24 of the signal terminals 202 are pressed against the insulative housing 1. The shield shell 3 can adjust the position and number of the contacting pads 311 according to the specific needs of the grounding terminals 201 of the electrical connector 100. The sidewalls 32 of the shield shell 3 cover outer surfaces of the guiding arms 11 of the insulative housing 1 and each defines a retaining arm 321 extending rearwardly from a rear edge thereof, the retaining arm 321 is received in the slot 111 located in the front side of the insulative housing 1 so that the shield shell 3 is fixed to the insulative housing 1. the soldering feet 33 of the shield shell 3 and the soldering portions 23 of the conductive terminal 2 are located in a same horizontal plane.

When the electrical connector 100 is connected with the mating connector, the resilient contacting arms 24 of the grounding terminal 201 connect with the contacting pads 311 of the shield shell 3 so that the mating connector can have a grounding function without grounding bar. Understandably, the notch 310 is formed corresponding to the interaction area defined by the resilient contacting arms 24, and it can adjust the position of the contacting pads 311 of the shield shell 3 according to the needs to connect with a selected resilient contacting arm 24 of the conductive terminals 2 to establish a grounding path achieving a grounding function.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the board general meaning of the terms in which the appended claims are expressed.

What is claimed is:

1. An electrical connector, comprising:
an insulative housing defining a plurality of terminal slots;
a plurality of conductive terminals retained in the insulative housing and arranged in a row, each terminal including a retaining portion received in the terminal slot, a contacting portion extending forwardly from a front portion of the retaining portion, a soldering portion extending outside of the insulative housing from the retaining portion and a resilient contacting arm extending forwardly from a rear portion of the retaining portion; and
a shield shell covering the insulative housing, the shell defining a notch at a rear portion thereof to receive the contacting arm therein and at least a contacting pad extending and disposed in the notch; wherein
the plurality of conductive terminals include a plurality of grounding terminals and signal terminals, and the at least one contacting pad contacts with the contacting arm of one of said grounding terminals.

2. The electrical connector as described in claim 1, wherein the at least one contacting pad of the shield shell are flat to abut against a top face of the insulative housing, the contacting arms upwardly and forwardly extend into the notch, and the contacting arm of the grounding terminal elastically press the at least one contacting pad of the shield shell.

3. The electrical connector as described in claim 2, wherein the shell defines a plurality of contacting pads each corresponding to a contacting arm of a grounding terminal, and the contacting arms of the signal contacts are disposed in the notch to press the top face of the insulative housing.

4. The electrical connector as described in claim 1, wherein each terminal defines a barb obliquely and rearwardly extending from a top edge of the retaining portion, each conductive terminal is assembled to the terminal slot from the rear side of the insulative housing and retained in the insulative housing by an interference fit of the barb.

5. The electrical connector as described in claim 4, wherein the contacting portion defines a pair of opposite elastic arms providing a pair of projecting portion opposite to each other, the contacting arm and the soldering portion extend from the upper and lower edges of the rear portion of the retaining portion respectively.

6. The electrical connector as described in claim 1, wherein the shield shell defines a body portion shielding the insulative housing, a pair of sidewalls extending downwardly from the front end of the body portion and a pair of feet each bending from a lower edge of the sidewall, the notch is located at a rear portion of the body portion.

7. The electrical connector as described in claim 1, wherein the insulative housing defines a mating cavity running through a front side thereof, the contacting portion defines a pair of elastic arms arranged in a vertical direction and located in the mating cavity.

8. The electrical connector as described in claim 7, wherein a recess depresses from a top surface of the insulative housing for receiving the shield shell.

9. The electrical connector as described in claim 8, wherein the insulative housing defines a pair of guiding arms forwardly extend from both sides thereof, and the shield shell covers the guiding arms to form an engaging space therebetween for receiving a mating connector.

10. The electrical connector as described in claim 8, wherein the shield shell defines a pair of sidewalls each attaching to an outer surface of the guiding arm, a pair of retaining arms each extending rearwardly from the sidewall and a pair of soldering feet each bending from a lower edge of the sidewall, the retaining arms are inserted into the housing from a front side thereof.

11. The electrical connector as described in claim 10, wherein the soldering feet of the shield shell and the soldering portions of the conductive terminals are located in a same horizontal plane.

12. An electrical connector, comprising:
an insulative housing defining a longitudinal mating cavity running through a front face thereof;
a plurality of conductive terminals retained in the housing, and each defining a retaining portion received in the housing, a contacting portion forwardly extending from a front portion of the retaining portion and projecting into the mating cavity, and a soldering portion extending outside of the housing from a rear portion of the retaining portion; and
a shield shell covering the insulative housing;
wherein the plurality of conductive terminals includes a grounding contact, and the grounding contact defines a resilient contacting arm bending upwardly from an upper edge of the rear portion of the retaining portion and extending forwardly to contact with the shield shell.

13. An electrical connector comprising:
an insulative housing defining a mating slot extending along a longitudinal direction and forwardly communicating with an exterior in a front-to-back direction perpendicular to said longitudinal direction;
one row of passageways arranged along said longitudinal direction and formed in the housing and communicating with the mating slot;
a plurality of contacts disposed in the corresponding passageways, respectively, each of said contacts including a front mating section extending into the mating slot, a rear lower tail section for mounting a printed circuit board, and an upper resilient arm above the mating section, the resilient arms of all said contacts commonly defining an interaction area along said longitudinal direction; and
a metallic shell assembled upon and covering the housing, said shell defining a planar body portion with a common notch in a rear edge dimensionally corresponding to the interaction area; wherein
a plurality of contacting pads unitarily extending from a notch edge of the body portion into said notch so as to mechanically and electrically connect to the resilient arms of the selected contacts, respectively, for establishing and unifying grounding paths thereof.

14. The electrical connector as claimed in claim 13, wherein the contacting pads are immovable in connection with the corresponding resilient arms.

15. The electrical connector as claimed in claim 13, wherein the body portion is seated upon a top face of the housing, the resilient arms is located above the top face of the housing in a vertical direction perpendicular to both said longitudinal direction and said front-to-back direction, and each of the contacting pads is sandwiched between the resilient arm of the corresponding selected contact and the top face of the housing in said vertical direction.

16. The electrical connector as claimed in claim 13, wherein the resilient arms, which are not connected with the contacting pads, abut against a top face of the housing in a vertical direction perpendicular to both said front-to-back direction and said longitudinal direction.

17. The electrical connector as claimed in claim 13, wherein the shell is configured to be rearwardly assembled upon the housing in said front-to-back direction while said contacts are configured to be forwardly assembled into the corresponding passageways in said front-to-back direction.

18. The electrical connector as claimed in claim 13, wherein said contacting pads extend rearwardly in said front-to-back direction.

19. The electrical connector as claimed in claim 13, wherein the resilient arm extends forwardly while the tail section extends rearwardly in said front-to-back direction.

20. The electrical connector as claimed in claim 13, wherein said shell is configured to be rearwardly assembled upon the housing along said front-to-back direction with corresponding soldering feet upwardly exposed to an exterior in a vertical direction perpendicular to both said longitudinal direction and said front-to-back direction.
